(19) United States
(12) Patent Application Publication
(10) Pub. No.: US 2005/0190398 A1
(43) Pub. Date: Sep. 1, 2005

(54) Multifunction peripheral for data collection and distribution

(76) Inventors: Jayasimha Nuggehalli, Union City, CA (US); Jerry Hong, San Jose, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 10/791,335

(22) Filed: Mar. 1, 2004

(51) Int. Cl. G06F 15/00

(52) U.S. Cl. 358/1.15

(57) ABSTRACT

Techniques are provided for a multifunction peripheral for data collection and distribution comprising a multifunction peripheral configured to perform the steps of requesting device-related information from a network device over a network; receiving device-related information from the network device over the network; generating a device-related report based on said device-related information; and sending said device-related report to a recipient device.

### RELATED APPLICATION DATA

This application is related to U.S. patent application Ser. No. 10/253,203, Attorney Docket Number 49986-0511, filed Sep. 23, 2002, entitled “Multi-Function Peripheral,” with Seiichi Katano listed as the inventor, the contents of which are hereby incorporated by reference in its entirety for all purposes.

This application is related to U.S. patent application Ser. No. 10/639,004, Attorney Docket Number 49986-0531, filed Aug. 11, 2003, entitled “Configuring a Graphical User Interface on a Multifunction Peripheral,” with Seiichi Katano listed as the inventor, the contents of which are hereby incorporated by reference in its entirety for all purposes (referred to herein as '004).

This application is related to U.S. patent application Ser. No. 10/639,052, Attorney Docket Number 49986-0532, filed Aug. 11, 2003, also entitled “Configuring a Graphical User Interface on a Multifunction Peripheral,” with Seiichi Katano listed as the inventor, the contents of which are hereby incorporated by reference in its entirety for all purposes (referred to herein as '052).

### FIELD OF THE INVENTION

The present invention relates to multifunction peripherals. The invention more specifically relates to a multifunction peripheral for data collection and distribution.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

A multifunction peripheral (MFP) is a single device that performs several functions. Many MFPs are equipped to perform as printers, scanners, facsimile machines, and copiers. Because they can perform many functions, they are advantageous over their single function counterparts. Moreover, consumers prefer MFPs because purchasing one is often less expensive than separately purchasing a printer, scanner, facsimile machine, and copier. Because of their usefulness and versatility, MFPs are very common in the workplace.

In fact, many companies use MFPs as part of their day-to-day operation. For example, businesses may use the MFPs to print up a report, make copies of the report, send the report to someone else, or even scan a picture to put in the report. From a business perspective, a MFP is valuable because it saves the company money and allows their employees to be more efficient and productive.

In many cases, the vendor of a multifunction peripheral must receive information about the multifunction peripherals in order to be able to charge appropriately for its use, to ensure that it is functioning properly, and to ensure that consumables are appropriately provided, among other things. In the past, the method of providing this device-related information was for a human operator at the site of the multifunction peripheral to either check the device itself and construct a report or print out a report of the device-related information and send it to the vendor, who could then act on the information by providing consumables, fixing the machine, and/or charging appropriately. In addition, this data collection must be done for every device. The human operator, usually an employee of the client or the vendor, must ensure that all of the information from all of the devices was gathered and sent to the appropriate vendor.

This method, however, is time consuming and error prone. Accordingly, there is an unaddressed need in the art to simplify the collection and distribution of device-related information.

### SUMMARY

Techniques are provided for multifunction peripheral data collection and distribution. The techniques provide a multifunction peripheral for collecting data from one or more network devices, and from the multifunction peripheral itself. The multifunction peripheral compiles this data in reports and sends it to a recipient device such as a fax machines, an email account, or an FTP, HTTP, or HTTPS server or client.

Overall the techniques simplify the collection and distribution of device-related information.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that depicts a multifunction peripheral according to one embodiment of the invention.

FIG. 2 is a flow diagram depicting the steps for collecting and distributing device-related information.

FIG. 3 is a flow diagram depicting the configuration of a multifunction peripheral.

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Structural Overview

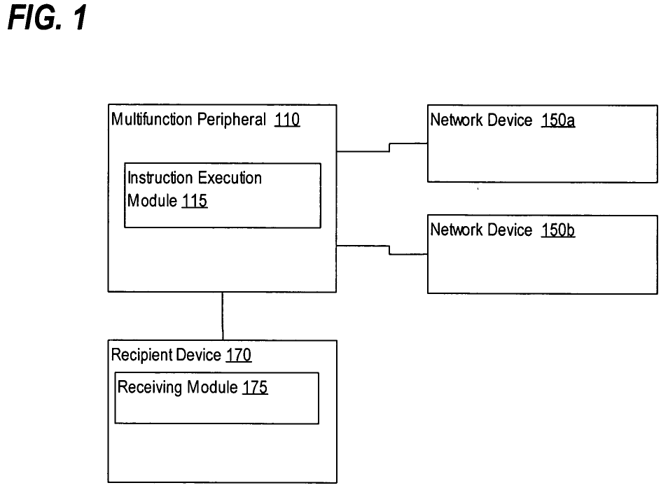

FIG. 1 is a block diagram that depicts a multifunction peripheral 110 according to one embodiment of the invention.

The multifunction peripheral 110 is communicatively coupled to two network devices 150a and 150b. The multifunction peripheral 110 is also communicatively coupled to a recipient device 170.

Multifunction peripheral 110, as used herein, is broadly used to refer to any multifunction peripheral capable of performing the functionality of two or more of: a printer, a scanner, a facsimile machine, and a copier. For ease of explanation herein, FIG. 1 depicts one multifunction peripheral 110; however, embodiments of the invention can also operate with two or more MFPs 110.

Multifunction peripheral 110 can include an instruction execution module 115. An instruction execution module 115 may be hardware or software instructions executing on hardware that is capable of executing instructions. One example of an instruction execution module 115 is a java virtual machine (JVM). In the case where the instruction execution module 115 is a JVM, the instruction executed by the JVM may include a java application.

The instruction execution module 115 may execute on a general purpose processor within a multifunction peripheral 110 or may execute on dedicated hardware on the multifunction peripheral 110. The multifunction peripheral 110 may also contain machine-readable medium for storing instructions to be executed in the instruction execution module 115 and for providing storage of data retrieved from network devices 150a and 150b, usage data for the multifunction peripheral 110, or data produced by the instructions executed on the instruction execution module 115. A description of hardware upon which the instruction execution module 115 may be implemented is included in the section entitled Hardware Overview.

The multifunction peripheral 110 may also include a communication mechanism such as a wired network interface, a wireless network interface, infrared communication mechanisms, a telephone wire interface, a direct cabling interface, or any other appropriate communication mechanisms. The multifunction peripheral 110 may also include an identification module that includes an identifier unique to the multifunction peripheral 110. This identifier may be used to identify the multifunction peripheral 110 in device-related reports.

In various embodiments, the multifunction peripheral 110 may include a file transfer protocol (FTP) server or client, a hypertext transfer protocol (HTTP) server or client, a secure http (HTTPS) server or client, a simple network management protocol (SNMP) agent, or an email server or client. Such clients or servers may be executed as part of the instruction execution module 115, as part of another module in the multifunction peripheral 110 or as part of another device communicatively coupled to the multifunction peripheral 110.

The communicatively coupling of the multifunction peripheral 110 with the recipient device 170, the network device 150a, the network device 150b, and with any other device may be implemented by any medium or mechanism that provides for the exchange of data between MFP 110 and the communicatively coupled device. Examples of communicatively coupling include, without limitation, networks such as Local Area Networks (LAN), Wide Area Networks (WAN), Ethernet or the Internet, direct cabling, infrared transmission, or one or more terrestrial, satellite or wireless links.

Network devices 150a and 150b, as used herein, refer to any computerized device capable of communicating with a multifunction peripheral 110. Non-limiting, illustrative examples of devices 150a and 150b include multifunction peripherals, facsimile machines, scanners, printers, or copiers. For ease of explanation, FIG. 1 depicts two network devices 150a and 150b; however, embodiments of the invention may operate with one or more network devices. In various embodiments, network devices 150a and 150b each include a communication mechanism such as a wired network interface, a wireless network interface, infrared communication mechanisms, a telephone wire interface, a direct cabling interface, or any other appropriate communication mechanisms. The network devices 150a and 150b may also include machine-readable media to store device-related information.

Recipient device 170 as used herein, is broadly used to refer to any computerized device capable of communicating with a multifunction peripheral 110. Non-limiting, illustrative examples of recipient device 170 include a laptop computer, a cell phone, a personal digital assistant (PDA), a facsimile machine at a server, and a wireless device. For ease of explanation, FIG. 1 is depicted with one recipient device 170; however, embodiments of the invention may operate with any number of devices, including a recipient device 170 or two or more recipient devices 170.

The recipient device as depicted includes a receiving module 175. The receiving module 175 may execute on a general purpose processor within a receiving device 170 or may execute on dedicated hardware on the receiving device 170. The receiving device 170 may also contain a machine-readable medium for storing instructions to be executed in the receiving module 175 and for providing storage of data retrieved from the multifunction peripheral 110 or data produced by the instructions executed on the receiving module 175 (e.g. log files). A description of hardware upon which at least a portion of the receiving module 175 may be implemented is included in the section entitled Hardware Overview.

In various embodiments, the receiving module may be a FTP server or client, a HTTP server or client, a HTTPS server or client, a SNMP agent, or an email server or client.

In other embodiments, the recipient device does not contain a separate receiving module 175, but instead is configured to receive device-related reports. For example, a recipient device 170 may be a fax machine capable of receiving faxed documents.

In various embodiments, recipient device 170 may include a communication mechanism such as a wired network interface, a wireless network interface, infrared communication mechanisms, a telephone wire interface, a direct cabling interface, or any other appropriate communication mechanisms. The recipient device 170 may also include machine-readable medium usable for storing device reports.

For simplicity in explanation, the example herein depicts a recipient device 170 receiving device-related reports from a single multifunction peripheral 110. In other embodiments, a recipient device 170 may receive device-related reports from two or more multifunction peripherals 110.

### Functional Overview

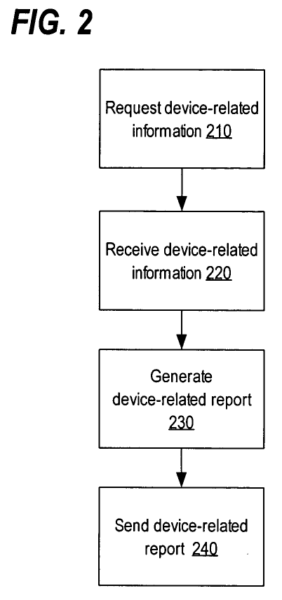

FIG. 2 is a flow diagram depicting the steps for collecting and distributing device-related information.

In step 210, device-related information is requested. This request may be in any appropriate protocol: SNMP; hypertext markup language (HTML); extensible markup language (XML); a proprietary customer resource management (CRM) format; or any other appropriate format. The request may be performed via any appropriate communication mechanism including TCP/IP sockets, a LAN, a WAN, an Ethernet or the Internet, direct cabling, an infrared transmission, or one or more terrestrial, satellite or wireless links.

For example, in the context of FIG. 1, the multifunction peripheral 110 requests device-related information from a network device 150a. In one embodiment, the multifunction peripheral 110 requests device-related information from multiple network devices 150a and 150b. In one embodiment, a multifunction peripheral requests device-related information from itself (e.g. by accessing a machine-readable medium containing the desired information).

In step 220, device-related information is received. The information may be in any appropriate protocol or format, such as, for example, SNMP, HTML, or XML. For example, in the context of FIG. 1, the multifunction peripheral 110 receives device-related information from a network device 150a. In one embodiment, the multifunction peripheral 110 receives device-related information from multiple network devices 150a and 150b. The multifunction peripheral 110 may also receive or access device-related information from itself (e.g. by receiving in memory the device-related information that had been in a machine-readable medium on the multifunction peripheral).

The device-related information may include device information, device status information, meter reading data, and consumables information. Device information may include vendor and model information (such as vendor name and model number) for the multifunction peripheral, firmware and software version information for the multifunction peripheral or for components of the multifunction peripheral. Device statues information may include service call numbers, device reachability, and device up/down status. Service call numbers may include predefined indicators of current, past, or reoccurring service issues, such as part failure or paper jams. Meter reading information may include, but is not limited to, total count of pages processed, number of print pages made, number of facsimile pages sent or received, and number of copies made. Each of these quantities may also be broken up into color and black and white. Consumables status may include the status of replaceable parts of the multifunction peripheral, such as light bulbs, gears, rollers, and hinges. Consumables may also include toner levels, paper levels, etc. In addition, the device-related report may have any of the above-mentioned information enumerated for each of the multiple network devices. For example, in the context of FIG. 1, the device-related report may contain two separate numbers: the number of copies for network devices 150a and the number of copies for 150b.

Step 210 and 220 may be performed on a recurring basis or may be initiated based on some initiating event. For example, a vendor of a multifunction peripheral may configure the multifunction peripheral to request device-related information once per day, week, or month, depending on the availability of network resources and the frequency at which steps 230 and 240 are executed (described below). As another example, if a vendor and client have agreed to a per-usage billing arrangement, the vendor may configure the multifunction peripheral to request device-related information on an hourly basis to ensure that the multifunction peripheral is able to detect within an hour when the combined usage on the network devices 150 a and 150 b has reached a predefined level.

In step 230, a device-related report is generated. The device-related report is generated based on the device-related information received in step 220. In various embodiments, the device-related report is generated based on information from a single network device, from two or more network devices, or from the multifunction peripheral and from one or more network devices. For example, in the context of FIG. 1, a multifunction peripheral 110 generates a report based on the meter reading information and the consumables information from network devices 150a and 150b and multifunction peripheral 110.

The device-related report may also contain an identifier for the multifunction peripheral that is sending the report. This may be important if, for example, the recipient device receives reports from more than one multifunction peripheral. The identifier makes it possible for the recipient device to easily differentiate among the multifunction peripherals from which device-related reports are sent.

In one embodiment, as part of step 230, device-related data from multiple network devices is aggregated. In various embodiments, aggregating data includes determining total values based on corresponding individual values for each network device or aggregating data based on corresponding individual values for each network device and based on corresponding values for the multifunction peripheral. For example, in the context of FIG. 1, step 230 includes determining the sum of the total pages printed by network device 150a, network device 150b, and multifunction peripheral 110.

In step 240, the device-related report is sent to a recipient device. The device-related report may be sent in any format using any appropriate protocol. For example, a device-related report may be formatted using comma-separated fields and sent using hypertext transfer protocol (HTTP). Other example formats include tab-delimited files, XML, HTML, Microsoft Excel, database export files, human-readable text documents, and binary files with defined formats. Other example protocols include FTP and HTTPS. The device-related report may also be sent via email using simple mail transfer protocol (SMTP) or any appropriate protocol. The device-related report may be faxed to the recipient device if the recipient device is capable of receiving faxes.

If, for example, a device-related report is sent to a recipient device and the recipient device includes a FTP, HTTP, or HTTPS server, then the sending device, e.g. a multifunction peripheral, may use a FTP, HTTP, or HTTPS client to initiate communication with the recipient device and send the report using FTP, HTTP, or HTTPS, respectively.

As another example, if the multifunction peripheral includes a FTP, HTTP, or HTTPS server, then the step 240 of sending a device-related report may be initiated by a recipient device. In such an embodiment, a FTP, HTTP, or HTTPS client at the recipient device would be used to initiation communication with and request the device-related report from the FTP, HTTP, or HTTPS server on the multifunction peripheral. The device-related report would then be uploaded from the multifunction peripheral to the recipient device. A common example of such a scenario would be is the multifunction peripheral has a HTTPS server and the recipient device includes a web browser. By browsing to a particular URL that points to an HTML (or XML, etc.) document accessible on the HTTPS server, the browser has initiated a request that will cause the HTTPS server to upload the document to the machine upon which the browser is executing.

It is also possible to require the recipient device to acknowledge the receipt of the device-related report. In such a case, the recipient device may send any type of acknowledgement, including: connection established, report received, and report is well-formatted. Various “connection established” responses are already part of the HTTP, HTTPS, and FTP protocols. A “report received” response may be used to signify that the recipient device has received the full report, and may be based on the recipient device determining a file size, checksum, or other method to ensure that the entire file was received. The “report well formatted” response may be returned by the recipient device in order to signify that the recipient device was able to access and parse the report. In various embodiments, one or more types of acknowledgement responses may be sent from the recipient device to the multifunction peripheral.

Another possible method of sending the device-related report may include sending the report using an electronic faxing (EFAX) service. Using such a service, the device-related report is sent over a network to an EFAX receiving device in an electronic format supported by the EFAX service. From the EFAX receiving device, the document is sent to a facsimile machine where it is then transmitted to the recipient device (a facsimile machine).

Step 230 and 240 may be performed on a recurring basis or it may occur based on some initiating event. For example, a vendor of a multifunction peripheral may configure the multifunction peripheral to send a meter report once per day, week, or month, depending on the billing cycle to which the vendor and client have agreed. As another example, if a vendor and client have agreed to a per-usage billing arrangement, the vendor may configure the multifunction peripheral to send a device-related report containing meter information whenever a certain number of events have occurred since the last device-related report was sent (e.g. a report may be sent every time 5000 copies were made).

The multifunction peripheral may also be configured to perform step 230 at different times for different information. For example, a vendor who has sold a multifunction peripheral to a client may want to receive device status information every 10 minutes (in order to facilitate providing better customer support), may receive consumables information once per day at 8:00 pm (in order to facilitate having toner and other consumables available for the next morning), and may receive one meter report for every 5,000 total copy, facsimile, and print pages.

The multifunction peripheral may also send device-related reports in response to a request from a recipient device. Such a request may be sent in any appropriate format (e.g. SNMP, XML, HTML, etc.) via any appropriate communication means (LAN, WAN, TCP/IP sockets, etc.). For example, in the context of FIG. 1, a recipient device 170 comprising a CRM application sends a request for device-related information to a multifunction peripheral 110.

Any of the communications between the multifunction peripheral and the network devices or between the multifunction peripheral and the recipient devices may be encrypted. For example, as part of an email exchange, the sender may use a public key provided by the recipient to encrypt the message so that only the recipient may decrypt the message. Any of these protocols may also be used through a secure tunnel, such as a virtual private network (VPN). In using a secure tunnel, the protocol functions as it does over public network, with the difference being that all of the communication packets sent are first encrypted by an encryption mechanism at the sender and later decrypted by an encryption device at the receiver. Some protocols, such as HTTPS provide encryption as part of the protocol. Details of how to implement encryption with various communication means can be found in many references including: “Planning for PKI: Best Practices Guide for Deploying Public Key Infrastructure” by Housley and Polk; Published by John Wiley & Sons.

### Example of Collecting Metering Data

This section provides an example of the techniques described herein for collecting and distributing metering data. The techniques described herein are in no way limited to this example. This example is provided for illustrative purposes.

In this example, a multifunction peripheral is configured to receive meter reading information from two network devices, which are also multifunction peripherals. The vendor of the multifunction peripheral has set up the multifunction peripheral to collect and aggregate device-related information from the network devices once per hour. The vendor of the multifunction peripheral has also configured the multifunction peripheral to generate and send device-related reports via fax to the vendor's fax machine whenever the “total number of pages” exceeds 5,000. In this example, the total number of pages is defined as the sum of the number of faxes sent or received and the number of copies made on each of the network devices and the multifunction peripheral.

Therefore, in operation, the multifunction peripheral of this example will request meter data from the network devices over the network hourly. The multifunction peripheral will aggregate this information in a machine-readable medium on the multifunction peripheral and check to see whether the sum of the number of fax pages sent or received and the number of copies made has exceeded 5,000. When the total number of pages exceeds 5,000, a metering report is generated and faxed to the vendor using the multifunction peripheral's faxing unit.

### Configuration

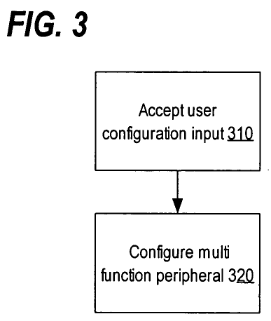

FIG. 3 is a flow diagram depicting the configuration of a multifunction peripheral.

The first step (step 310) to configuring a multifunction peripheral is accepting user configuration input. The multifunction peripheral will accept user configuration information via any appropriate means. For example, a multifunction peripheral may have a graphical user interface as described in '004 and '052. A multifunction peripheral may also have a remote interface. A remote interface is any interface that is accessible to a device not directly connected to the multifunction peripheral. For example, a remote interface may be a web page provided to a browser, executing on a personal computer not directly connected to the multifunction peripheral, by a HTTP or HTTPS server being executed on the multifunction peripheral or a device thereto communicatively coupled. A remote interface may also include a web service being executed as part of a web server being executed on the multifunction peripheral or a device thereto communicatively coupled. Additional remote interfaces may include remote programmable interfaces facilitated by remote procedure calls, TCP/IP sockets, or any appropriate communication mechanisms. Remote interfaces may also include applications being executed on a device other than the multifunction peripheral but communicating with multifunction peripheral using remote procedure calls, TCP/IP sockets, or any other appropriate communication mechanisms.

User configuration input may include frequencies at which device-related information should be gathered, the type of device-related information that should be gathered, the frequency at which device-related reports should be sent for each individual report type or for a set of report types, the format in which reports should be sent, and information to define the protocol and the communication mechanism.

In step 320, the configuration of the multifunction peripheral is altered based on the user configuration input. In one embodiment, the multifunction peripheral determines 1) whether the user has the authority to set up the multifunction peripheral; 2) whether the user configuration information is acceptable (e.g. that the desired configuration will not cause any problems, such as overburdening the network with too many reports); and 3) whether the user configuration input is correctly formatted.

In step 320, the configuration on the multifunction peripheral is changed to reflect the user configuration information collected in step 310. The configuration information may be stored in a machine-readable medium on the multifunction peripheral or device thereto communicatively coupled. Changing the configuration information may include changing values in the machine-readable medium that store the configuration information.

Various embodiments described herein enable a multifunction peripheral to collect data from multiple network devices, including the multifunction peripheral, aggregate and format that data in a format usable by the end user or by the recipient device, and send that data to the recipient device.

### Hardware Overview

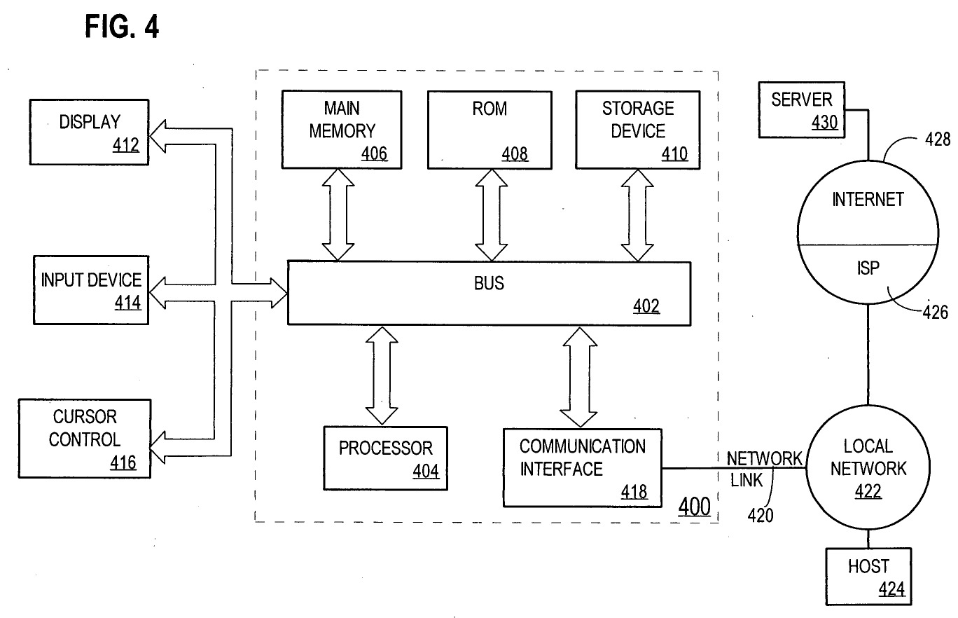

FIG. 4 is a block diagram that illustrates a computer system 400 upon which an embodiment of the invention may be implemented. The hardware depicted here may be part of a multifunction peripheral 110, a network device 150, a recipient device 170, or any other appropriate device. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 400, various machine-readable media are involved, for example, in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media may also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 may transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A multifunction peripheral configured to perform the steps of:
requesting device-related information from a network device over a network;
receiving device-related information from the network device over the network;
generating a device-related report based on said device-related information; and
sending said device-related report to a recipient device.

2. The multifunction peripheral of claim 1, wherein the multifunction peripheral is configured to perform the step of generating the device-related report based on said device-related information based at least in part on the recipient device.

3. The multifunction peripheral of claim 1, wherein the multifunction peripheral further comprises a faxing module and the multifunction peripheral is configured to perform the step of sending the device-related report by sending the device-related report via fax using the faxing module.

4. The multifunction peripheral of claim 1, wherein the multifunction peripheral further comprises a network connection and the multifunction peripheral is configured to perform the step of sending the device-related report by sending the device-related report to an electronic faxing service over the network connection.

5. The multifunction peripheral of claim 1, wherein the multifunction peripheral further comprises an email module and wherein the multifunction peripheral is configured to perform the step of sending said device-related report to the recipient device by sending said device-related report to the recipient device via email using the email module.

6. The multifunction peripheral of claim 1, wherein the multifunction peripheral further comprises a hypertext transfer protocol module and wherein the multifunction peripheral is configured to perform the step of sending said device-related report to the recipient device by sending said device-related report to the recipient device via hypertext transfer protocol using the hypertext transfer protocol module.

7. The multifunction peripheral of claim 1, wherein the multifunction peripheral further comprises a secure hypertext transfer protocol module and wherein the multifunction peripheral is configured to perform the step of sending said device-related report to the recipient device by sending said device-related report to the recipient device via secure hypertext transfer protocol using the secure hypertext transfer protocol module.

8. The multifunction peripheral of claim 1, wherein the multifunction peripheral further comprises a file transfer protocol module and wherein the multifunction peripheral is configured to perform the step of sending said device-related report to the recipient device by sending said device-related report to the recipient device via file transfer protocol using the file transfer protocol module.

9. The multifunction peripheral of claim 1, wherein the multifunction peripheral further comprises an encryption module and wherein multifunction peripheral is further configured to perform the step of encrypting the device-related report.

10. The multifunction peripheral of claim 1, wherein the multifunction peripheral further comprises an identification module and wherein multifunction peripheral is further configured to perform the steps of retrieving an identifier for the multifunction peripheral and augmenting the device-related report with the identifier for the multifunction peripheral.

11. The multifunction peripheral of claim 1, wherein the multifunction peripheral is configured to perform the step of requesting device-related information from a device at regular intervals.

12. The multifunction peripheral of claim 1, wherein the multifunction peripheral is configured to perform the step of requesting device-related information using the simple network management protocol.

13. The multifunction peripheral of claim 12, wherein the multifunction peripheral is configured to perform the step of receiving device-related information from the network device using the simple network management protocol.

14. The multifunction peripheral of claim 1, wherein the device-related information comprises one or more of device information, device status, meter reading information, and consumables information.

15. The multifunction peripheral of claim 1, wherein the multifunction peripheral is further configured to perform the step of accepting user configuration input, and wherein the user configuration input relates to one or more aspects of the collection of device-related information from the network device by the multifunction peripheral.

16. The multifunction peripheral of claim 1, wherein the multifunction peripheral is further configured to perform the step of accepting user configuration input via a remote interface, and wherein the user configuration input relates to one or more aspects of the collection of device-related information from the network device by the multifunction peripheral.

17. The multifunction peripheral of claim 15, wherein the multifunction peripheral is further configured to perform the step of requesting device-related information from a device at intervals defined by the user configuration input.

18. The multifunction peripheral of claim 15, wherein the multifunction peripheral is configured to perform the step of generating the device-related report based in part on the user configuration input, and wherein the multifunction peripheral is further configured to perform the step of sending said device-related report to the recipient device at an interval defined by the user configuration input.

19. The multifunction peripheral of claim 1, wherein the multifunction peripheral further comprises a means for executing instructions of a java application and the steps are performed by instructions of a particular java application.

20. The multifunction peripheral of claim 1, wherein the network device is a second multifunction peripheral.

21. The multifunction peripheral of claim 1, wherein the recipient device is one of the group consisting of a fax machine, a computer, and dedicated hardware executing one of the group consisting of an email client, an http server, and https server, and an ftp server.

22. The multifunction peripheral of claim 1, wherein the multifunction peripheral is configured to perform the step of:
requesting a second set of device-related information from a second network device over a network, wherein the network device is distinct from the second network device;
receiving the second set of device-related information from the second network device over the network;
generating the device-related report based on said device-related information and said second set of device-related information; and
sending said device-related report to the recipient device.

23. The multifunction peripheral of claim 1, wherein the multifunction peripheral is configured to perform the step of:
accessing a second set of device-related information from the multifunction peripheral;
generating the device-related report based on said device-related information and said second set of device-related information; and
sending said device-related report to the recipient device.

24. The multifunction peripheral of claim 1, wherein the multifunction peripheral is configured to receive an acknowledgement over the network from the network device.

25. A multifunction peripheral configured to perform the steps of:
requesting meter data from a second multifunction peripheral over a network;
receiving meter data from the second multifunction peripheral over the network;
generating a meter report based on said meter data; and
sending said meter report to a recipient device.

26. A multifunction peripheral comprising:
means for requesting meter data from a second multifunction peripheral over a network;
means for receiving meter data from the second multifunction peripheral over the network;
means for generating a meter report based on said meter data; and
means for sending said meter report to a recipient device.

27. A multifunction peripheral comprising:
means for requesting device-related information from a network device over a network;
means for receiving device-related information from the network device over the network;
means for generating a device-related report based on said device-related information; and
means for sending said device-related report to a recipient device.
